(19) United States
(12) Patent Application Publication
(10) Pub. No.: US 2005/0262112 A1
(43) Pub. Date: Nov. 24, 2005

(54) Method and apparatus to convert project plans into workflow definitions

(76) Inventor: Dennis B. Moore, Burlingame, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/851,352

(22) Filed: May 21, 2004

(51) Int. Cl. G06F 7/00

(52) U.S. Cl. 707/100

(57) ABSTRACT

A method and system to convert project plans into workflow definitions are described. The system includes a project information reader, a workflow metadata converter, a workflow steps converter, and a workflow phases converter. The project information reader is adapted to receive project data associated with a project. The workflow metadata converter is adapted to convert the project header into workflow metadata. The workflow steps converter is adapted to convert the project task into a workflow step. The workflow phases converter is adapted to convert a milestone associated with the project data into a workflow phase. In an event where there are no the milestones associated with the project data, the workflow phases converter creates a workflow phase if it is determined that the workflow process requires a workflow phase. The system further includes a roles module to assign a role to the workflow step.

### FIELD OF THE INVENTION

One embodiment relates generally to enterprise project workflow systems, and more particularly to a method and system to convert project plans into workflow definitions and workflow-based systems.

### BACKGROUND OF THE INVENTION

Software applications in the field of enterprise resource planning (“ERP”) attempt to integrate all facets of a business including planning, manufacturing, sales, and marketing. As the ERP methodology has become more popular, software applications have emerged to help business managers implement ERP in business activities such as inventory control, order tracking, customer service, finance, and human resources. For example, software tools have been developed to allow a user to create project plans, communicate them to others, and manage changes as they occur.

There are software tools in existence to allow converting a project plan from one project management system into another project management system or to convert workflow diagrams into workflow-based systems.

### SUMMARY OF THE INVENTION

According to the one exemplary embodiment there is provided a method and system to convert project plans into workflow definitions and running workflow-based systems.

According to one aspect, a system to convert a project plan into a workflow process includes a project information reader to receive project data associated with a project, the project data including a project header and a project task; and a workflow metadata converter to convert the project header into workflow metadata. The system further includes a workflow steps converter to convert the project task into a workflow step; and a roles module to assign a role to the workflow step. Still further, the system includes a workflow phases converter to convert a milestone associated with the project data into a workflow phase, responsive to identifying the milestone associated with the project data; and create the workflow phase in accordance with the project data, responsive to failure to identify the milestones associated with the project data, if it is determined that the workflow process requires a workflow phase.

Other features of the present invention will be apparent from the accompanying drawings and from the detailed description, which follows.

### BRIEF DESCRIPTION OF THE DRAWINGS

The present invention is illustrated by way of example and not limited in the figures of the accompanying drawings, in which like references indicate similar elements and in which:

FIG. 1 is a block diagram of a system to convert project plans into workflow definitions, according to one embodiment of the present invention.

FIG. 2 is a flow diagram of a method to convert project (including its sub-projects, milestones, and tasks) into a workflow (including sub-processes, phases, and steps), according to one embodiment of the present invention.

FIG. 3 is a flow diagram illustrating converting all milestones into phases, according to one embodiment of the present invention.

FIG. 3A is another flow diagram illustrating converting a milestone into a phase, according to one embodiment of the present invention.

FIG. 4 is a flow diagram illustrating mapping sub-projects to tasks, according to one embodiment of the present invention.

FIG. 5 is a flow diagram illustrating converting all tasks into workflow steps, according to one embodiment of the present invention.

FIG. 5A is a flow diagram illustrating converting a task into a workflow step, according to one embodiment of the present invention.

FIG. 6 is a flow diagram illustrating assigning roles, according to one embodiment of the present invention.

FIG. 7 is a network diagram of a system utilizing a method to convert project plans into workflow definitions, according to one embodiment of the present invention.

FIG. 8 is a diagrammatic representation of a computer system, within which a set of instructions, for causing the machine to perform any one or more of the methodologies discussed herein, may be executed.

### DETAILED DESCRIPTION

A method and system to convert project plans into workflow definitions are described. In the following description, for purposes of explanation, numerous specific details are set forth in order to provide a thorough understanding of the present invention. It will be evident, however, to one skilled in the art that the present invention may be practiced without these specific details.

Project plans are often a one-time description of a recurring business process. When a project plan is entered into a project management system (such as, for example, SAP Project System, SAP cProjects, or Microsoft Project), the result may be a useful way for a project manager to enter data about a project and create various status reports. In some systems, it may be desirable to deliver project tasks to project team members as reminders as well as a form in which a project team member can enter information about the task including expected or actual completion date, the number of hours worked, and other relevant information. These capabilities may be achieved by a workflow system utilizing project plan information.

A workflow system may exist as a generalized project plan. A workflow system may take in project plan information, convert it into workflow definitions, and then commence execution of the project plan. Execution of a project plan may include identifying an individual responsible for a project task, notifying that individual of the particulars of the task and the task deadlines, obtaining information from the individual regarding the completion status of the task and dispatching the next task sequence once the previous task sequence is completed. In some cases (more common in workflow systems than in project plans), certain tasks may be automated or outsourced, so that the “processor” is not a person in the organization but is instead a software program or another organization.

One of the unfortunate realities of current project planning systems is that almost all of the information within such project planning systems is optional. In contrast, in a workflow system, there may be a variety of required parameters. Thus, when a project plan is converted into workflow definitions, the parameters that are required by the workflow system (e.g., at least one workflow phase or a unique workflow step name) may need to be disambiguated or created. In one exemplary embodiment, a workflow system is responsible for notifying a person of an assignment to perform a workflow step, and therefore requires that each workflow step has a role assigned to that workflow step. Thus, if a project task corresponding to a workflow step does not have a role associated with the task, the workflow system may need to create a default role. Similarly, if a workflow system is unable to determine an action that corresponds to a particular workflow step, a default action created by the system may be a notification to a responsible individual, a request to provide a completion status, and a dispatch to the next workflow step if the particular workflow step is completed. A notification sent by a workflow system may be represented by a form, such as, for example, a dynamic web page or an electronic mail message. Such a form may include a check box and instructions to the user to check the check box if the workflow step has been completed. Other information that may be included in the form could include fields to enter number of hours worked so far or as of a specified date, fraction or percentage of task completed so far or as of a specified date, expected date of completion, comments on the task, discussion threads on the task, documents to attach to this task, and other information.

It may be desirable that a workflow system is used over and over again to run business projects within an organization. Because project specific information may vary between the projects, in one exemplary embodiment, a workflow definitions converter may be implemented to convert project data into workflow definitions.

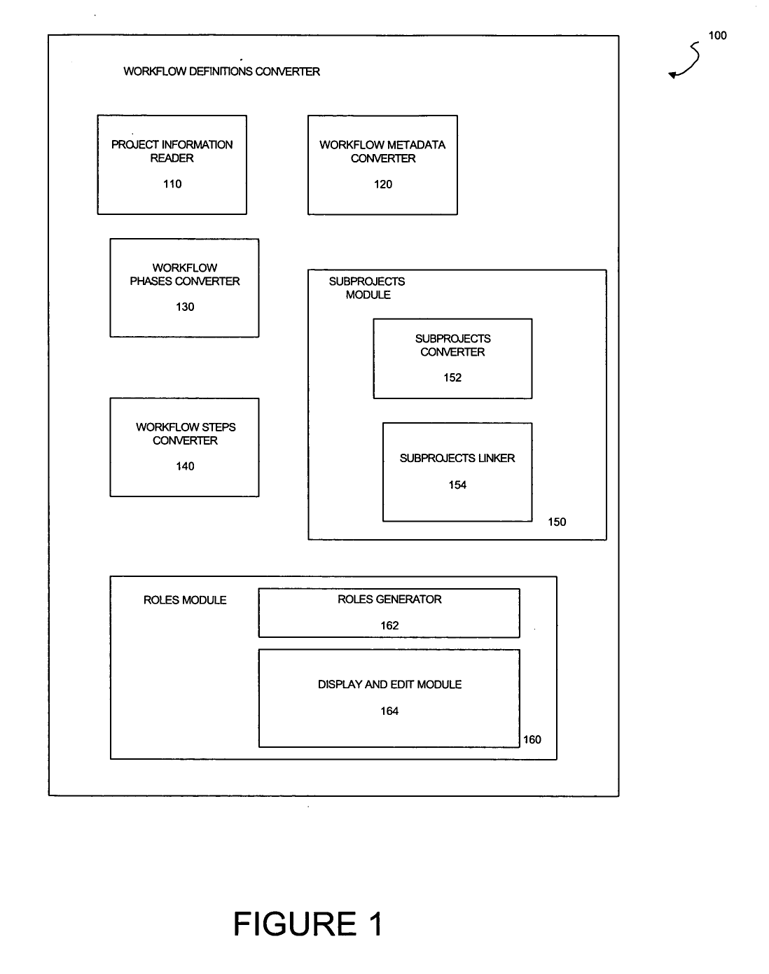

Referring to FIG. 1, a system 100 is a workflow definitions converter 100. The workflow definitions converter 100 includes a project information reader 110, a workflow metadata converter 120, a workflow phases converter 130, a tasks steps converter 140, a sub-projects module 150 and a rules module 160. The project information reader 100 may be configured to receive project information and to provide this project information to the workflow metadata converter 120, to the workflow phases converter 130, and to the tasks steps converter 140. The sub-projects module 150 includes a sub-projects tasks converter 152 and a sub-project master project linker 154. The sub-projects tasks converter 152 may be used to create a workflow for a sub-project that can function as an independent workflow, and also to link the sub-project workflow with the master project. The conversion for any sub-projects within a main project may be performed recursively.

The roles module 160 may include a roles generator 162 and a roles display and edit module 164. The roles generator 162 is responsible for generating a role for each task. The roles generator 162 may be configured to generate roles utilizing project information, which may be provided by the project information reader 110. The roles generator 162 may also be configured to generate roles by applying default rules available to the workflow system. The roles display and edit module 164 may be utilized to enable a user to view the roles and to edit the roles if necessary. A role may be a person, a group of people, or an automated system adapted to carry out a task in the workflow.

In one exemplary embodiment, the roles for the steps of the workflow system may be automatically derived from project information. A workflow system may be configured to react to an encounter of an undefined role by stopping and asking an appropriate individual (e.g., a process originator or an administrator) to provide the workflow system with information regarding a particular resource assigned to this role or the resource needs for this role. In some workflow systems, it may be desirable to separate roles from individual team members. In one exemplary embodiment, a workflow system may be configured to accept one or more requirements (e.g., resource needs) for a particular role, to identify one or more individuals satisfying the requirements, and to present the role along with the requirements to the administrator. Thus, a workflow system may be configured to create a role by converting resource needs associated with a workflow step into a role associated with the workflow step. If it is determined that a workflow step does not have specific resource needs, then a unique role is created according to the rules utilized by the workflow system.

In one example, a resource requirement for a task of “sending out an offer letter” may be indicated in the project information as “Joe Smith”. The workflow system then may convert the task of “sending out an offer letter” into a workflow step and create a role associated with this workflow step, the role having a name of “Joe_Smith_role”. The workflow system may then enable the administrator to view this created role and give the role a more appropriate title, such as a “hiring_manager”.

In one exemplary embodiment, a workflow system may be configured to enable the administrator to indicate that the generalized workflow system should associate a task of “sending out an offer letter” with the “hiring manager” resource need. This capability may be described as taking a specific project and making it into something that would be a repeatable business process that would be more useful in general situations.

Returning to FIG. 1, the workflow definitions converter 100 may be utilized where a project plan was generalized to be a workflow process, or a workflow system. Once a generalized workflow process is in place, each time there is a new project plan a new instance of the workflow process may be invoked. Once a specific instance of the workflow process is invoked, the system 100 creates an instance specific project name, instance specific workflow phases, instance specific workflow tasks, as well as defines the roles for the workflow steps. A generalized workflow process may exist as a workflow system and may be described as a workflow template.

The workflow definitions converter 100 may be functioning automatically or it may be configured to be manually assisted. For example, the workflow definitions converter 100 may create the roles and the tasks based solely on the information provided with the project information and by applying the workflow rules to this information. The workflow definitions converter 100 may also prompt the user to provide the information that was missing in the project information obtained by the project information reader 110, and to enhance or confirm data derived or generated by the workflow system.

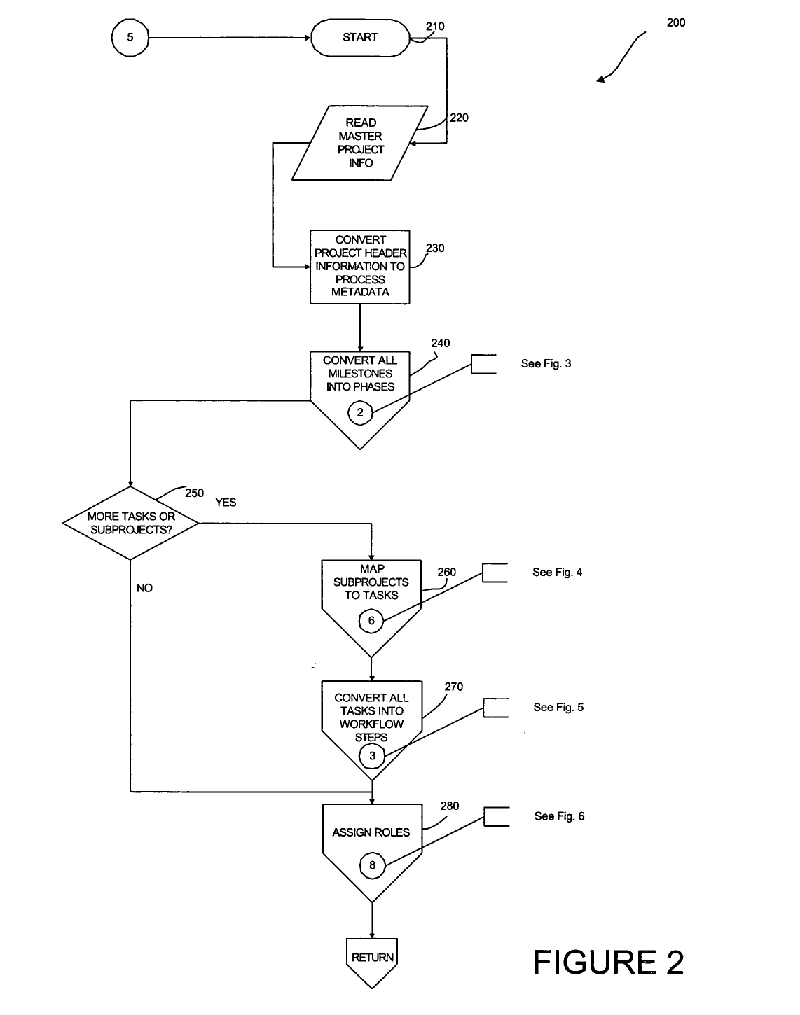

FIG. 2 is a flow diagram of a method 200 to convert project plans into workflow definitions. The method 200 starts at operation 210. At operation 220, the project information reader 110 obtains or receives project information. The project information is provided to the workflow metadata converter 120. At operation 230, the project header information is converted into workflow metadata. The project metadata information may include project name, project milestones, project tasks, project start date, project end date, project duration, project status, and other information. At operation 240, the project milestones identified in the project data are converted into workflow phases. Operation 240 may be accomplished by the workflow phases converter 130. If there are no milestones present in the project information and it is determined that the workflow system requires at least one workflow phase, then at least one phase (e.g., a default phase) is created either by utilizing default rules or by requesting the necessary project information from a user (e.g., an administrator). For example, if no milestones information is available in the project information, the workflow system may create a default workflow phase that corresponds to the entire duration of the project. It will be noted that if a workflow system does not require at least one workflow phase, then the absence of milestones in the project information will not necessarily trigger the creation of a default workflow phase.

In one exemplary embodiment, the project data obtained by the project information reader 110 may include sub-projects information, in which case the project including a sub-project may be referred to as a main or master project. At operation 250, the workflow system identifies the tasks or sub-projects in the master project information. In one exemplary embodiment, the sub-project may be treated as one of the tasks if the master project (or main project) and may also be linked to the main project as a task. A workflow system may be configured to allow users to access sub-projects as independent workflows. At operations 260 and 270, the sub-projects are converted into independent workflow processes utilizing the sub-projects converter 152. The sub-projects may be linked to the main or master workflow process as workflow steps, utilizing sub-project linker 154.

At operation 270, the project tasks are converted into workflow steps utilizing the tasks steps converter 140. Workflow step metadata, in one exemplary embodiment, may include a task name, and a task status (e.g., completed, started, delayed), start date, and other information. Workflow step metadata may also include information about a resource assigned to the associated workflow task, as well as information regarding whether a workflow step can be performed in parallel with another workflow step, or whether the completion of a predecessor workflow step is required.

Workflow step metadata may also include information about notification requirements for the workflow step. For example, if an associated task is to pour a foundation, then the notification requirement may instruct the workflow system to issue a notification three weeks in advance, so that an individual assigned to this workflow step has enough time to, for example, schedule a truck and order in the cement. Other workflow steps, such as, for example, scheduling an inspection, may require a notification, which is not as far in advance.

In one exemplary embodiment, a workflow system may require that each workflow step has an associated role. A workflow system may also require that the role is resolved to one individual (e.g., a person or an automated system). In one exemplary embodiment, a role must resolve to an individual at the point where an associated workflow step is executed by the workflow system. For example, when a workflow instance is first launched, a project owner may be required to identify a team member responsible for a particular task corresponding to a workflow step. A workflow system may also wait to prompt the project owner to enter this information until the time the particular workflow step is about to be executed by the workflow system, or this information may be created as a result of the workflow operations (e.g., the output of a previous step may include the processor for a future step), or this information may be derived at execution time for the workflow (e.g., “this step is to be executed by the manager of the person who executed the previous step”).

At operation 280, the rules associated with project tasks or workflow steps are assigned or created, if needed, by the workflow system. The information related to roles may be presented to a user for confirmation or for corrections if not all required information is present or can be resolved by the workflow system. For example, if the workflow system is unable to create a necessary role, then the user may be prompted to provide additional information necessary to create a role. The roles may be created by the roles generator 162. The display of the roles to a user is accomplished utilizing roles display and edit module 164.

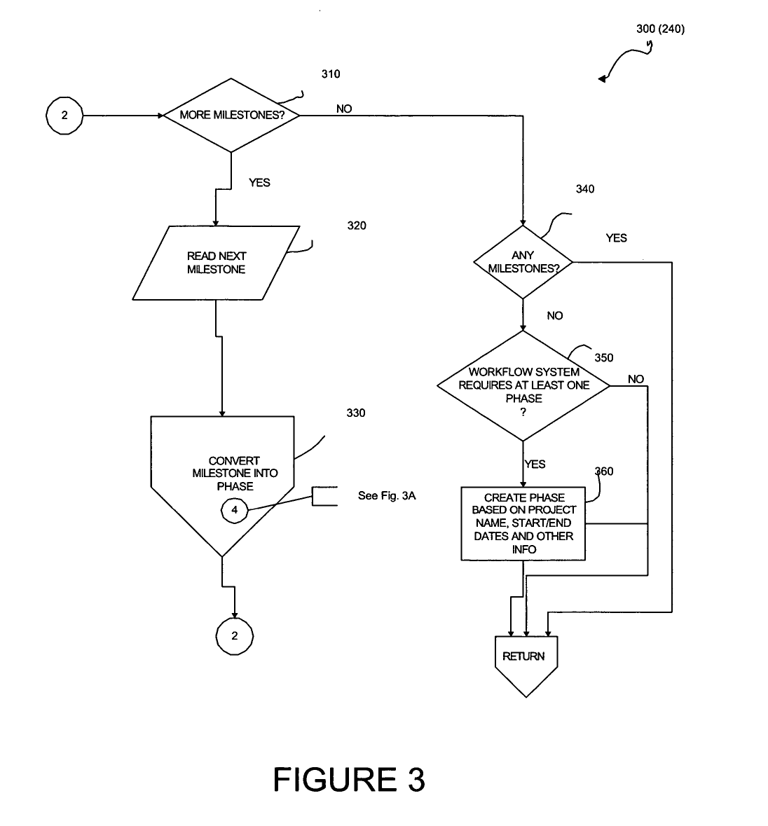

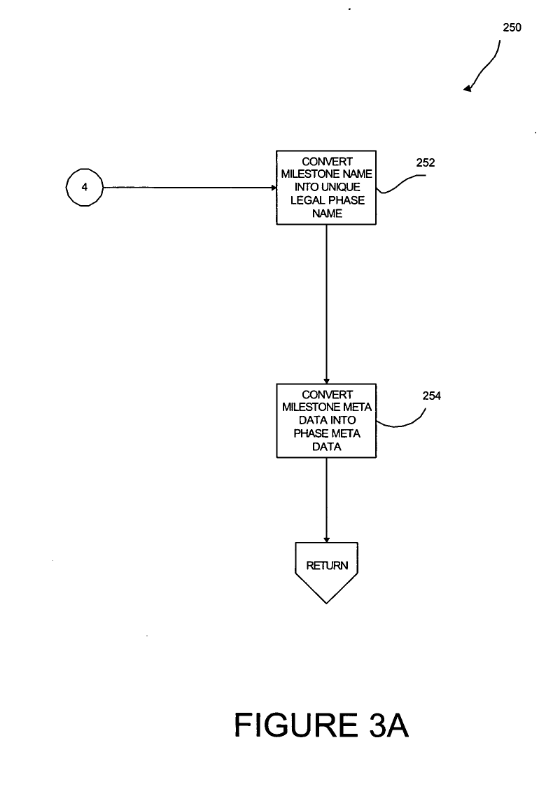

FIG. 3 is a flow diagram illustrating a method 300 to convert project milestones into workflow phases, according to one exemplary embodiment. The method 300 starts at operation 310. When a project milestone is encountered within project information at operation 320, the project milestone is converted into an associated workflow phase at operation 330. If it is determined at operation 340 that there are no milestones present in the project information, the workflow system determines at operation 350 whether at least one phase is required. If the workflow system requires at least one phase, then a default workflow phase is created at operation 360 utilizing the project name, the start and end dates of the project and other information. If, however, the workflow system does not require any phases, then the method 300 proceeds without creating a default phase.

FIG. 3A is another flow diagram illustrating a method 250, corresponding to the operation 250 of FIG. 2, to convert a project milestone into a workflow phase according to one embodiment. In the method 250, a project milestone name is converted into a unique legal workflow phase name at operation 252. At operation 254, project milestone metadata is converted into workflow phase metadata. Workflow phase metadata may include workflow phase start and end dates, workflow phase duration, and other information.

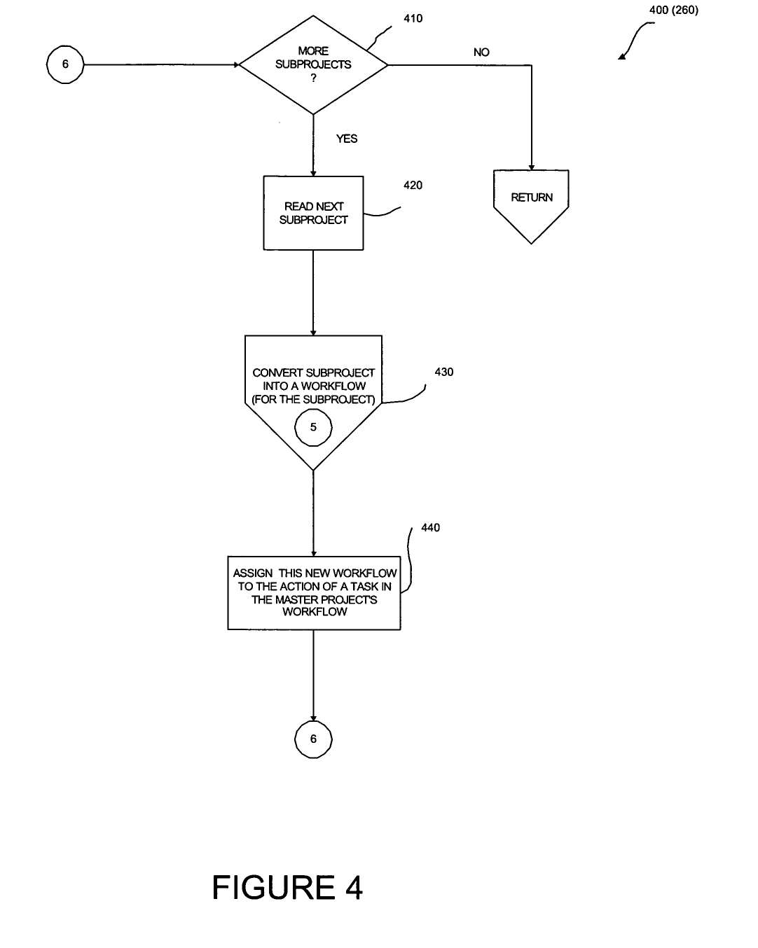

FIG. 4 is a flow diagram illustrating a method 400 to map sub-projects to workflow tasks, according to one embodiment. The method 400 corresponds to the operation 260 in FIG. 2. The method 400 starts at operation 410. If it is determined at operation 410 that there are more sub-projects to be processed, the method 400 proceeds to operation 420 to access the next sub-project. At operation 430 the sub-project is converted into a workflow for the sub-project. It will be noted that operations to convert the sub-project into a workflow for the sub-project correspond to method 200 illustrated in FIG. 2. Thus, the method 200 may be called recursively for each sub-project. At operation 440, the workflow system assigns an action of the task in the master project's workflow. The tasks steps converter 140 may be configured to convert each project task into a request for completion/progress information from a user, where the request for completion/progress information from a user is a default action. In one embodiment, the tasks steps converter 140 may be configured to enable a user to select an action from a list of actions that may be appropriate for the workflow step. For example, a user who manually accesses conversion process performed by the tasks steps converter 140 may select an action to be performed by the workflow step, which is distinct from a default action of confirming a task status or another default action.

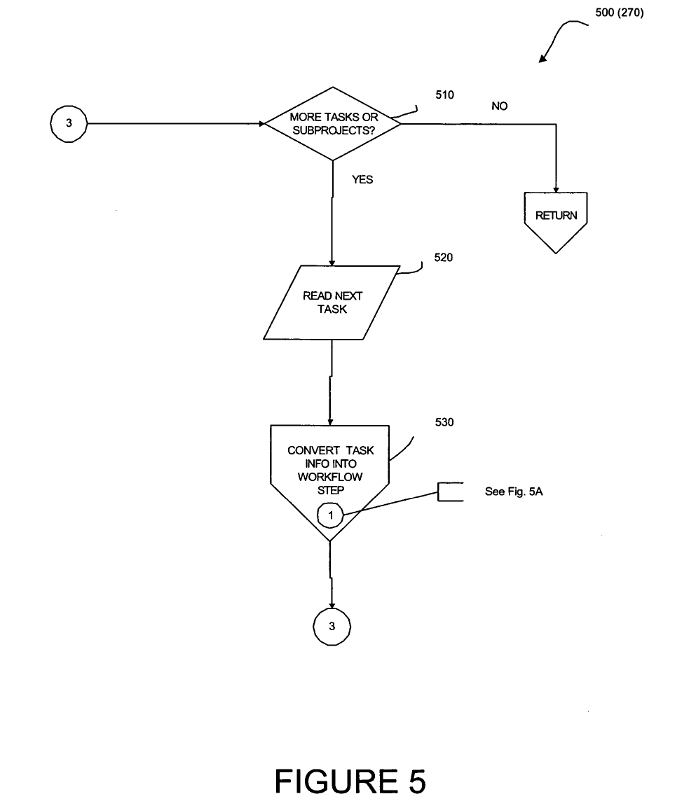

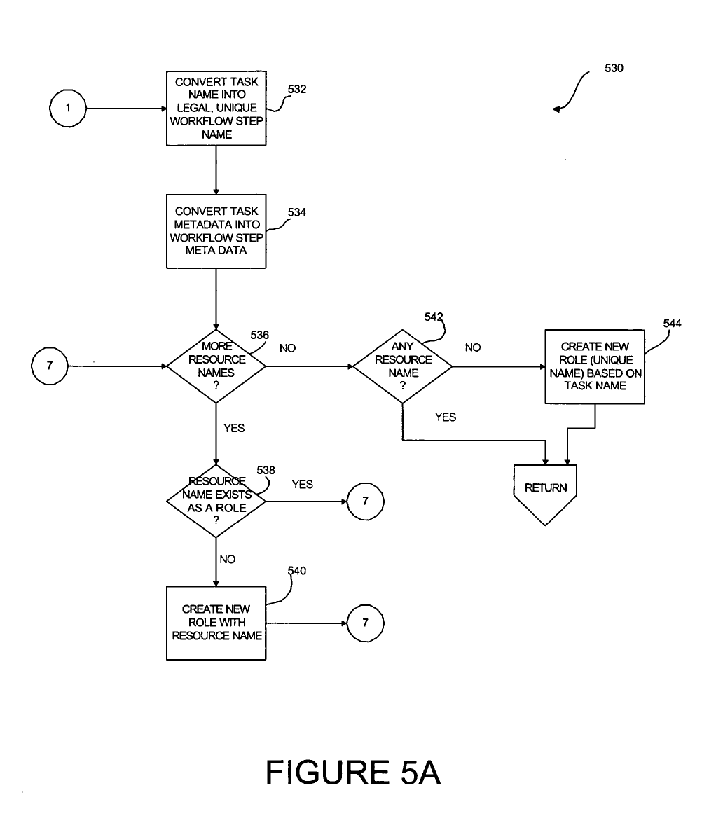

FIG. 5 is a flow diagram illustrating a method 500 to convert project tasks into workflow steps according to one embodiment. The method 500 corresponds to the operation 270 in FIG. 2. A workflow system identifies a next task or a next sub-project at operation 510. The workflow system reads the next task at operation 520 and converts the next task into a workflow step at operation 530. The operation 530 is described in more detail in FIG. 5A.

FIG. 5A is another flow diagram for a method 530 illustrating converting task information into workflow step metadata according to one embodiment. At operation 532, a project task name is converted into a legal unique workflow step name. At operation 534, project task metadata is converted into workflow step metadata. In one exemplary embodiment, a workflow system may require that each workflow step has a role associated with it. At operations 536 and 538, the workflow system processes resource names associated with a project task. If it is determined that no resource name exists as a role, then a new role is created with a resource name at operation 540. If it is determined at operations 542 that no resource name is available in the project information, then a new role with a unique name based on the project task name is created at operation 544.

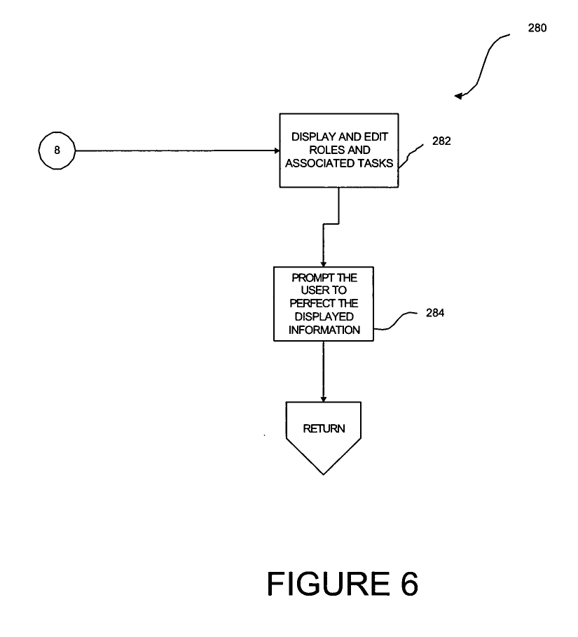

FIG. 6 is a flow diagram illustrating a method 280 to assign roles to tasks according to one embodiment. The method 280 corresponds to the operation 280 of FIG. 2. At operation 382, the roles with the associated workflow steps are displayed to the user. At operation 384, the user may be prompted to perfect the displayed information at operation 284. For example, a user may be prompted to replace a generic role name (e.g., a role name corresponding to the associated workflow step name) with a more specific role name (e.g., a role name reflecting a resource requirement for the role). Similarly, a user may be prompted to replace a more specific role name (e.g., a role name reflecting a name of an individual) with a more functional role name (e.g., a role name reflecting a resource requirement for the role).

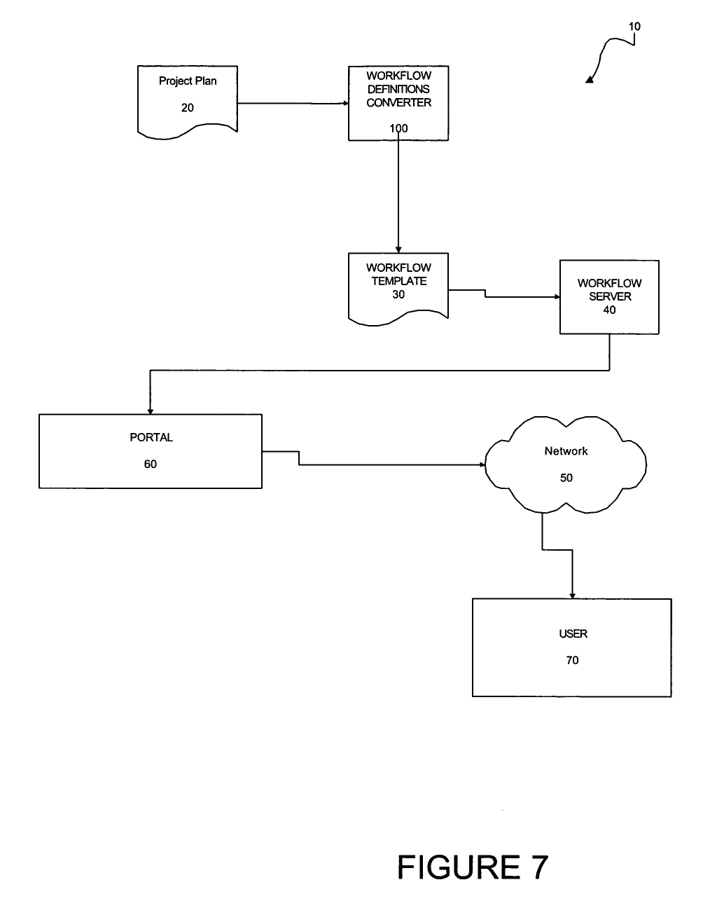

FIG. 7 is a network diagram of a system 10 utilizing the method 200 to convert project plans into workflow definitions according to one embodiment of the present invention. A project plan 20 is provided to the converter 100. The converter 100 converts the project plan 20 into workflow definitions to create a new workflow system (e.g., a workflow definition or a workflow template 30). It will be noted that a workflow definition may be in an XML format, a proprietary format or any other appropriate format. The workflow template 30 is linked to a portal 60 via a workflow server 40 and a network 50. A user 70 may access the workflow template 30 via the portal 60. Continuing with the system 10, the workflow template 30 may be termed a definition of a generalized workflow process. The workflow server 40 accesses a workflow definition (e.g., the workflow template 30) and creates a workflow instance according to specific project data. A workflow instances may be launched manually or utilizing the portal 60. In one exemplary embodiment, a workflow instance based on the workflow template 30 may be launched utilizing a workflow agent. The workflow agent may reside on an integration server and may monitor events generated by workflow systems. For example, a workflow system may generate an event corresponding to an order being placed. A rules engine, which may reside on an integration server, may determine which rules are applicable to that event. In turn, a workflow agent may determine the applicability of the rules and whether there is a need for an action in response to the event.

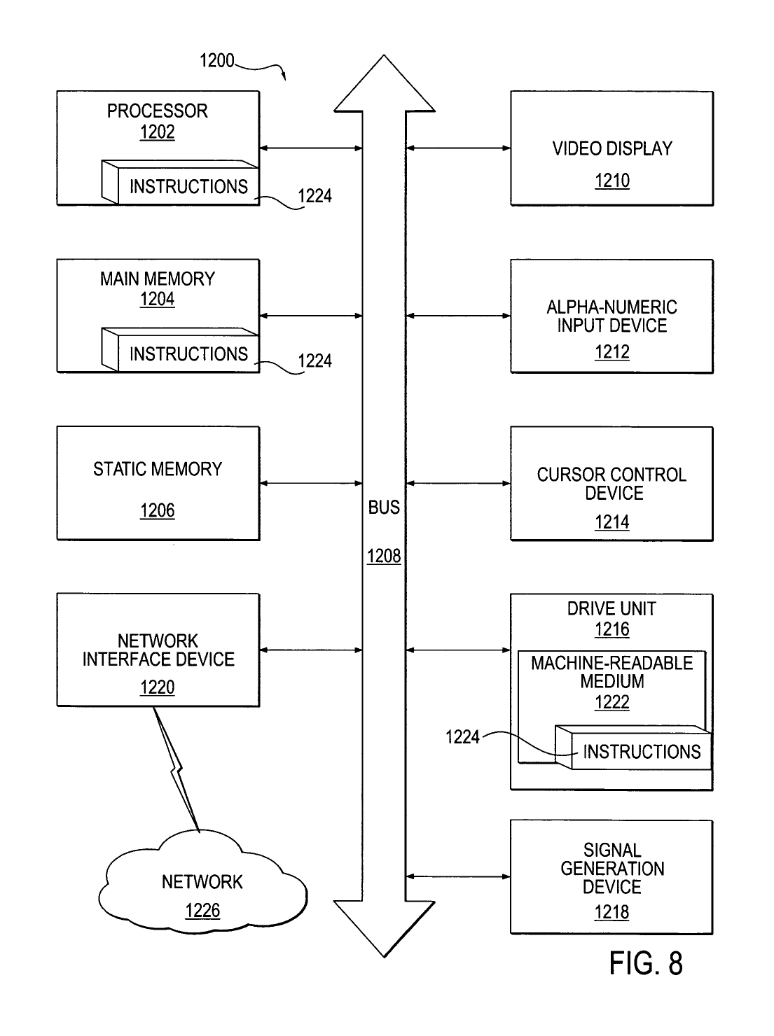

FIG. 8 illustrates a diagrammatic representation of machine in the exemplary form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU) a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1218 (e.g., a speaker) and a network interface device 1220.

The disk drive unit 1216 includes a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media. The software 1224 may further be transmitted or received over a network 1226 via the network interface device 1220.

While the machine-readable medium 1222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to convert project plans into workflow definitions have been described. Although the present has been described with reference to specific exemplary embodiments, it will be evident that various modifications and changes may be made to these embodiments without departing from the broader scope and spirit of the invention. Accordingly, the specification and drawings are to be regarded in an illustrative rather than a restrictive sense.

1. A system to convert a project plan into a workflow process, the system including:
a project information reader to receive project data associated with a project, the project data including a project header and a project task; and
a workflow metadata converter to convert the project header into workflow metadata.

2. The system of claim 1 including:
a workflow steps converter to convert the project task into a workflow step; and
a roles module to assign a role to the workflow step.

3. The system of claim 1 including a workflow phases converter to:
convert a milestone associated with the project data into a workflow phase, responsive to identifying the milestone associated with the project data; and
create the workflow phase in accordance with the project data, responsive to failure to identify the milestones associated with the project data, if it is determined that the workflow process requires a workflow phase.

4. The system of claim 3, wherein the workflow phases converter is to:
create a unique legal workflow phase name for the milestone; and
convert metadata for the milestone into metadata for the associated workflow phase.

5. The system of claim 2, wherein the workflow steps converter is to:
create a unique legal workflow step name for the project task; and
convert metadata for the project task into metadata for the associated workflow step.

6. The system of claim 2, wherein the roles module is to:
identify a resource associated with the project task; and
create a role for a workflow step associated with the project task, the role being based on the name of the resource.

7. The system of claim 2, wherein the roles module is to:
create a role for a workflow step associated with the project task, the role being based on the name of the project task.

8. The system of claim 2, wherein a project is a sub-project associated with a main project.

9. The system of claim 8, including a sub-projects converter to convert the sub-project into an independent workflow.

10. The system of claim 9, wherein the sub-projects converter is to link the sub-project with the main project, the sub-project being linked with the main project as a task.

11. A method to convert a project plan into a workflow process, the method including:
receiving project data associated with a project, wherein the project data includes a project header and a project task; and
converting the project header into workflow metadata.

12. The method of claim 11 including:
converting the project task into a workflow step; and
assigning a role to the workflow step.

13. The method of claim 11 including:
converting a milestone associated with the project data into a workflow phase, responsive to identifying the milestone associated with the project data; and
creating at least one workflow phase in accordance with the project data, responsive to failure to identify the milestone associated with the project data, if it is determined that the workflow process requires a workflow phase.

14. The method of claim 12, wherein the converting of the milestone associated with the project data into the workflow phase includes:
creating a unique legal workflow phase name for the milestone; and
converting metadata for the milestone into metadata for the associated workflow phase.

15. The method of claim 12, wherein the converting of the project task into the workflow step includes:
creating a unique legal workflow step name for the project task; and
converting metadata for the project task into metadata for the associated workflow step.

16. The method of claim 12, wherein the assigning of the role for the workflow step includes:
identifying a resource associated with the project task; and
creating a role for the workflow step associated with the project task, the role being based on the name of the resource.

17. The method of claim 12, wherein the assigning of the role for the workflow step includes:
creating a role for the workflow step associated with the project task, the role being based on the name of the project task.

18. The method of claim 12, wherein the project is a sub-project associated with a main project, the method including enabling a user to access the sub-project workflow process as an independent workflow process or as a project task associated with the main project.

19. A method to convert a project plan into a workflow process, the method including:
means for receiving project data associated with a project, wherein the project data includes a project header and a project task; and
means for converting the project header into workflow metadata.

20. The method of claim 19 including:
means for converting the project task into a workflow step; and
means for assigning a role to the workflow step.

21. The method of claim 19 including:
means for converting a milestone associated with the project data into a workflow phase, responsive to identifying the milestone associated with the project data; and
means for creating the workflow phase in accordance with the project data, responsive to failure to identify the milestones associated with the project data, if it is determined that the workflow process requires a workflow phase.

22. A machine-readable medium embodying a sequence of instructions that, when executed by a machine, cause the machine to:
receive project data associated with a project, wherein the project data includes a project header and one or more project tasks; and
convert the project header into workflow metadata.
